(19) United States
(12) Patent Application Publication
(10) Pub. No.: US 2018/0249719 A1
(43) Pub. Date: Sep. 6, 2018

(54) BAKE-OFF OVEN SYSTEM AND METHOD

(71) Applicant: LEVENS COOKING & BAKING SYSTEMS B.V., Gilze (NL)

(72) Inventors: Johannes Jozephus Gerardus VAN LOON, Tilburg (NL); Edwin Gert Jan VERHOEVEN, Dongen (NL)

(73) Assignee: LEVENS COOKING & BAKING SYSTEMS B.V., Gilze (NL)

(21) Appl. No.: 15/753,156

(22) PCT Filed: Aug. 17, 2016
(86) PCT No.: PCT/NL2016/050580

§ 371 Date: Feb. 15, 2018

(30) Foreign Application Priority Data
Aug. 17, 2015 (NL) 2015311

(51) Int. Cl. A21B 3/07; A21B 1/26; A21B 7/00; A23L 5/10

(52) U.S. Cl. CPC A21B 3/07; A21B 1/26; A23V 2002/00; A23L 5/15; A21B 7/00

(57) ABSTRACT

A bake-off oven system and method for baking off food products are described. The method for baking off food products includes baking off pre-baked products to be baked such as bread. The food products to be baked off are held in an infeed unit and the baked-off food products are held in an outfeed unit. A lift system moves a bake-off compartment between compartments of an infeed unit and compartments of an outfeed unit.

The present invention relates to a bake-off oven system. The invention further relates to a method for baking off food products, particularly baking off pre-baked products to be baked such as bread, bread rolls and viennoiserie (Danish pastries, custard buns, croissants, pains au chocolat and so on).

Bake-off ovens are known from the prior art. The Netherlands patent NL1023925 thus describes a bake-off oven comprising a bake-off compartment, an inlet tray and an outlet tray. A continuously drivable conveyor belt which extends through the bake-off compartment is arranged here between the inlet tray and outlet tray. The inlet tray is provided with an intermittently drivable shaker plate.

The baking time is determined in the above stated system by the time the food products spend in the bake-off compartment. When sufficient food products have been exported and space has thus been created on the conveyor belt, the shaker plate can be driven so as to deposit pre-baked food products from the inlet tray onto the conveyor belt by means of a shaking movement.

The above stated system has the advantage that the process of baking off requires less human intervention. Food products are moreover baked off on location, for instance in a supermarket, whereby the freshness of the products can be better guaranteed.

The above stated system however has a number of drawbacks. A first drawback is related to the fact that the above stated system is configured to bake off a single type of product, i.e. products having substantially the same baking time. If the above stated system is to be employed to bake off other types of product, a user has to manually set the baking time to be used, and thereby the throughput time of the products in the bake-off compartment. The different types of product are further deposited in the same outlet tray, and the different products have to be supplied from the same inlet tray. The above stated system is therefore in practice frequently used in parallel, wherein a plurality of such systems is employed to bake off a corresponding plurality of different products.

A second drawback is related to the manner of supplying products to be baked off on the conveyor belt. Due to the mechanical movement to which the products to be baked are subjected on the shaker plate, as well as the falling movement made by these products from the inlet tray to the conveyor belt, the existing system is less suitable for baking off fragile products such as viennoiserie.

The present invention has for its object to provide a solution wherein the above stated problems of the existing system do not occur, or at least do so to lesser extent. The invention provides for this purpose a bake-off oven system comprising an infeed unit for holding food products to be baked off, a bake-off compartment for baking off food products to be baked off which are present in the infeed unit, and an outfeed unit for holding the food products baked off by the bake-off compartment. The bake-off oven system is characterized here in that the infeed unit and the outfeed unit each comprise a plurality of compartments and that the bake-off oven system further comprises a lift system for moving the bake-off compartment between the compartments of the infeed unit and the compartments of the outfeed unit.

According to the invention, the bake-off compartment is moved between the different compartments of the infeed unit and outfeed unit. This creates the option of dividing different food products to be baked off over different compartments of the outfeed unit. The baking process can likewise be optimized for the food products to be baked off which are present in the relevant compartment of the infeed unit. By making use of a lift system for displacing the bake-off compartment it is possible to bake off a plurality of types of food product to be baked off using one single bake-off compartment. The use of a lift system does not preclude such a system enabling a horizontal displacement of the bake-off compartment in addition to or instead of a vertical displacement.

In an embodiment each compartment of the outfeed unit is associated with a different outfeed position and, if the bake-off compartment is in a determined outfeed position, the bake-off compartment and the outfeed unit are configured to transport the food products baked off in the bake-off compartment to the compartment of the outfeed unit associated with the determined outfeed position. The outfeed unit can for example comprise a holder with several shelves, which are each placed at a different height. A shelf can in such a case comprise an inclining surface on which the baked-off food products are placed. The outfeed position will here mainly relate to the height of the bake-off compartment. The outfeed of the bake-off compartment can for instance be brought into line with an infeed opening of a shelf through which the baked-off food products can be carried onto the shelf by means of a conveyor belt.

In another or further embodiment each compartment of the infeed unit is associated with a different infeed position and, if the bake-off compartment is in a determined infeed position, the bake-off compartment and the infeed unit are configured to transport the food products to be baked off, which are situated in the compartment of the infeed unit associated with the determined infeed position, to the bake-off compartment.

The infeed unit comprises for example a trolley with several shelves. These shelves can each comprise a horizontal surface on which the food products to be baked off are placed, and can be embodied as drawers which can be taken or pulled at least partially out of the infeed unit in order to be replenished. The infeed position in this case also relates mainly to the height of the bake-off compartment. The infeed of the bake-off compartment can for instance be brought into line with an outfeed opening of a shelf through which the food products to be baked off can be carried into the bake-off compartment by means of a conveyor belt.

In the above stated embodiments the lift system is configured to move the bake-off compartment between the infeed positions and outfeed positions.

Each of the compartments of the outfeed unit can be provided with a respective sensor for detecting a degree of filling of the relevant compartment. The bake-off oven system can further comprise a control unit for controlling the lift system and the bake-off compartment subject to the detected degree of filling of the compartments of the outfeed unit. The sensor comprises for example an optical sensor with a light source and a photosensitive diode. The light source and the diode are disposed on either side of the compartment here, wherein the direction of detection, being the optical path between light source and diode, lies perpendicularly of the outfeed direction of the baked-off food products. Opting for a positioning of the sensor closer to the infeed opening of the compartment achieves that an empty signal is generated at a higher degree of filling of the compartment. The lift system and the bake-off compartment can be controlled on the basis of the empty signal to bake off the relevant food products. It is not precluded here that the infeed unit and/or the outfeed unit is also controlled on the basis of such a signal.

In a further embodiment each compartment of the infeed unit and each compartment of the outfeed unit is associated with one of a plurality of groups of food products to be baked off, wherein the control unit is configured to control the lift system, this after it has been detected that a degree of filling of a relevant compartment of the outfeed unit is less than a predetermined threshold value, such that the bake-off compartment is brought into an infeed position in order to receive from the infeed unit food products to be baked off, which belong to the group associated with this relevant compartment, to control the bake-off compartment to bake off these food products to be baked off, and to control the lift system such that the bake-off compartment is brought into a position to export these food products to the relevant compartment in order to increase the degree of filling.

Within the context of the present invention a group of food products to be baked off is understood to mean food products which are prepared with the same baking process in terms of duration and baking temperature. As specific example, a group consists only of identical food products, such as Kaiser rolls. In another example a group consists of a plurality of types of food product, such as Kaiser rolls and hard rolls, but these food products can be prepared by means of the same baking process.

The control unit can be configured to set parameters for the baking process for the bake-off compartment subject to the food products to be baked off. In an embodiment the control unit can be programmed to set baking parameters per compartment of the infeed unit. It is not precluded here that some or all different compartments have the same baking parameters. The control unit can also be provided with information about the infeed positions and outfeed positions for the bake-off compartment to be used in order to control the lift system so that the bake-off compartment can move between the compartments of the infeed unit and outfeed unit.

Programming of the control device can for instance take place by connecting this device to a computer or other programming device with which the user loads the baking parameters specific to the compartment into the control unit.

The bake-off compartment can comprise a conveyor belt and a drive unit for driving the conveyor belt. This drive unit can be configured to move the conveyor belt up and downward, at least during baking off of the food products. In such an embodiment there is no exchange of food products with the infeed unit or outfeed unit during the actual baking process, this in contrast to the above stated existing system. The up and downward movement of the food products, usually in a direction parallel to the conveyor belt, improves the baking process, enhances an even baking result, prevents burns on the food products and prevents uneven baking.

In a further embodiment each compartment of the infeed unit comprises an individually movable conveyor belt which can be coupled to the conveyor belt of the bake-off compartment such that after coupling the drive unit of the bake-off compartment drives both the conveyor belt of the bake-off compartment and the movable conveyor belt of a compartment for the purpose of transporting food products to be baked off from the compartment to the bake-off compartment. The movable conveyor belt of the compartment of the infeed unit and the conveyor belt of the bake-off compartment can each be mounted round a respective pair of shafts placed at a mutual distance, wherein at least one shaft of the pair of shafts of the infeed unit is coupled mechanically to a first engaging element and wherein at least one shaft of the pair of shafts of the bake-off compartment is coupled mechanically to a second engaging element, wherein the first and second engaging element can be brought into engagement with each other for said driving of the movable conveyor belt of the compartment of the infeed unit by the drive unit. The first and the second engaging element can each comprise a toothed wheel. Within the context of the present invention mechanical coupling is understood to mean that rotation of a shaft causes a rotation of an engaging element coupled mechanically to this shaft, and vice versa.

In an embodiment the infeed unit and/or the bake-off compartment comprises a pivotally mounted arm, which arm can pivot relative to the shaft to which an engaging element is coupled mechanically and wherein the engaging element is rotatably mounted on an end of the shaft remote from the shaft, wherein rotation of the shaft and rotation of the engaging element are coupled and wherein the infeed unit and/or the bake-off compartment comprises a second drive unit for allowing the arm to pivot for the purpose of bringing the engaging elements into engagement. The toothed wheel can thus be mounted on a further shaft, which is coupled by means of a transmission to the above stated shaft for the purpose of mechanically coupling the engaging element and the shaft.

The infeed unit can comprise a pivotally mounted protective bracket per compartment, which bracket is configured to be pushed away by the arm of the bake-off compartment during pivoting of the arm for the purpose of allowing the engaging elements to enter into engagement. Such a protective bracket can for instance prevent food products to be baked off falling from the infeed unit during transport of the infeed unit. The bake-off oven system can thus comprise a frame on which the lift system with the bake-off compartment is mounted, wherein the infeed unit comprises a mobile trolley which can be coupled to the frame. In such an embodiment it is possible to fill the trolley at a location remote from the frame, for instance by dividing different groups of food product over the compartments, and to then couple the trolley to the frame, after which the baking process can be started.

The bake-off compartment can comprise an upstream flap which is placed between the infeed unit and the bake-off compartment and a downstream flap which is placed between the bake-off compartment and the outfeed unit, wherein the control unit is configured to open the upstream flap prior to receiving from the infeed unit the food products to be baked off and to open the downstream flap after baking of these food products for the purpose of exporting these to the outfeed unit. Brushes can be provided on the underside of these flaps for cleaning the conveyor belt.

In an embodiment the bake-off compartment comprises a housing, a heat source for heating the air present in the bake-off compartment, a fan for causing a flow in the heated air, a distributing unit for distributing the heated air over the food products to be baked off and a collecting unit for collecting the air which has been distributed over the food products to be baked off. The distributing unit is in communication here with a blowing side of the fan and the collecting unit is in communication with the suction side of the fan. At least one of the collecting unit and the distributing unit can comprise here a perforated plate with a plurality of openings through which passes the air to be distributed and/or collected.

According to a further aspect, the object of the invention is achieved with a method for baking off food products to be baked off, comprising the steps of: providing an outfeed unit for holding baked-off food products, providing an infeed unit for holding food products to be baked off, wherein the infeed unit and the outfeed unit each comprise a plurality of compartments, wherein each compartment of the infeed unit and outfeed unit is associated with a different group of food products.

The method further comprises the step of detecting a degree of filling of each of the compartments of the outfeed unit. If the detected degree of filling of a relevant compartment lies below a predetermined threshold, a bake-off compartment is moved relative to the infeed unit by means of a lift system in order to reach a position suitable for receiving food products from the group associated with said relevant compartment, and these food products are received. The received food products are then baked off by the bake-off compartment. Finally, the bake-off compartment is moved relative to the outfeed unit by means of the lift system in order to reach a position suitable for exporting the baked-off food products to the relevant compartment, and the baked-off food products are exported to the relevant compartment.

The invention will be discussed in more detail hereinbelow with reference to the accompanying figures, wherein:

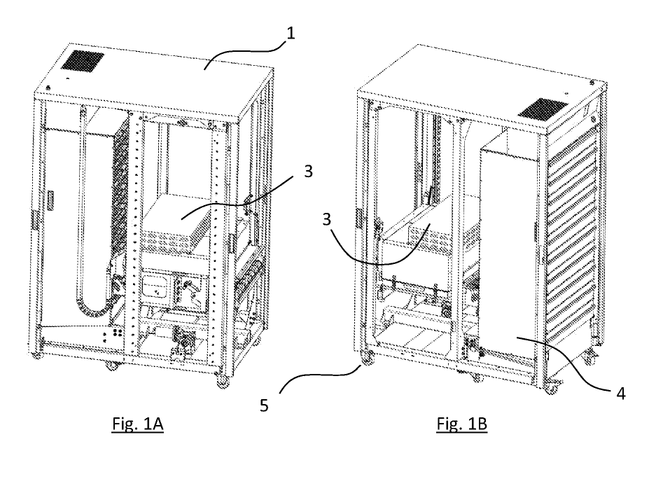

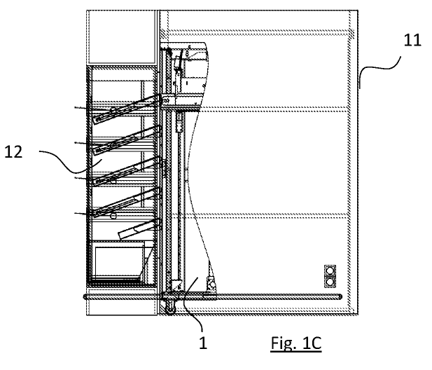

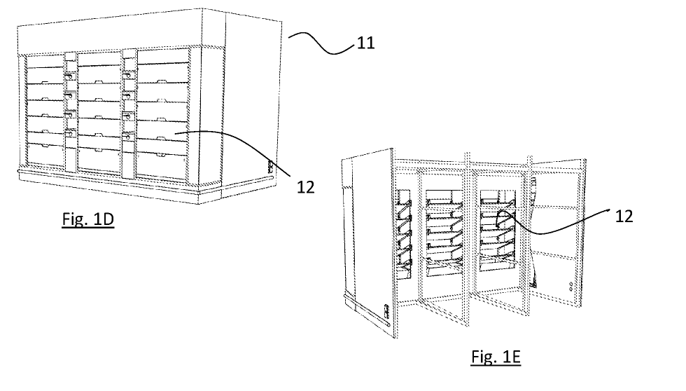

FIGS. 1A-1F show different views and details of an embodiment of a bake-off oven system according to the present invention;

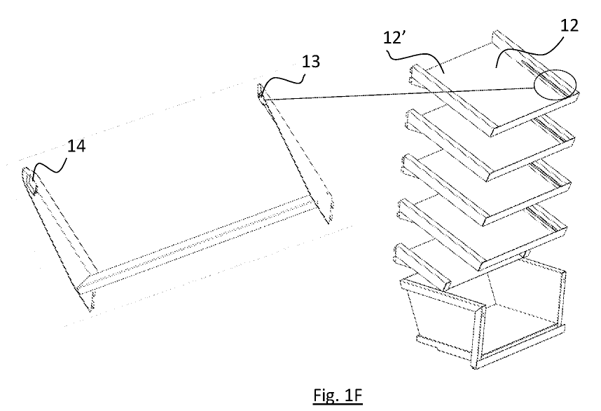

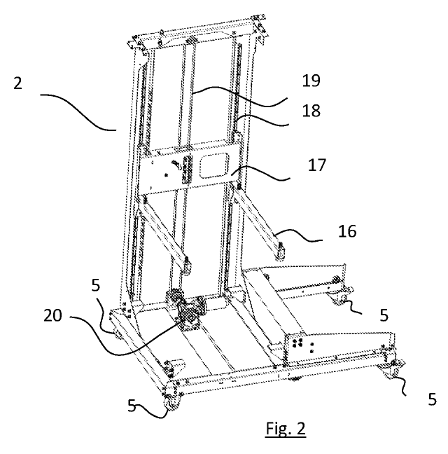

FIG. 2 shows a lift system of the bake-off oven system of FIG. 1A;

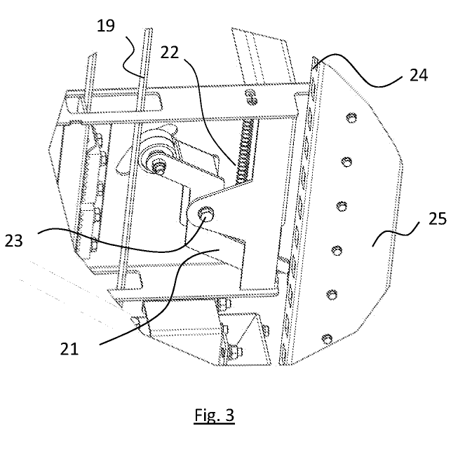

FIG. 3 shows a falling safety of the bake-off oven system of FIG. 1A;

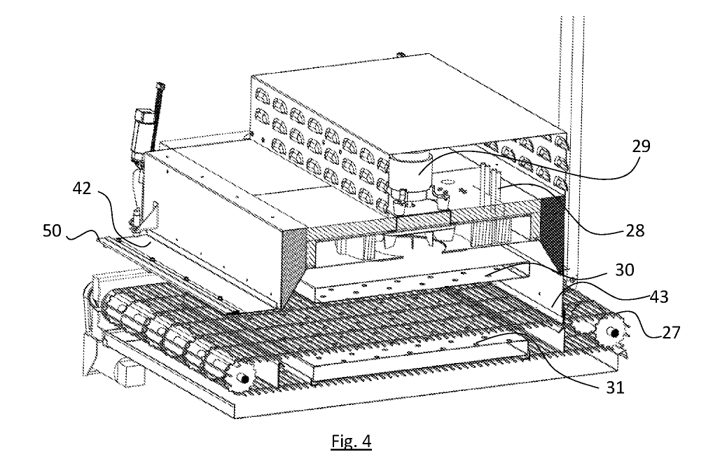

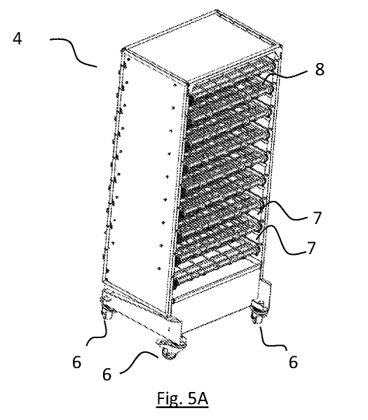

FIG. 4 shows a cross-section of the bake-off compartment of the bake-off oven system of FIG. 1A;

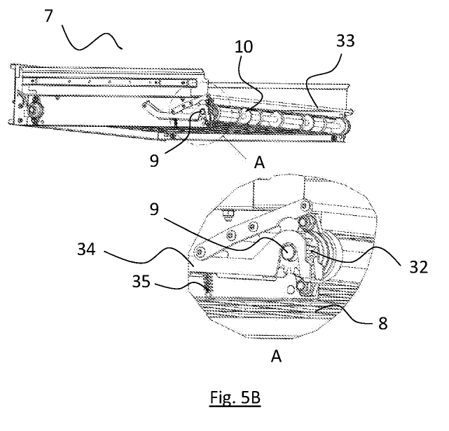

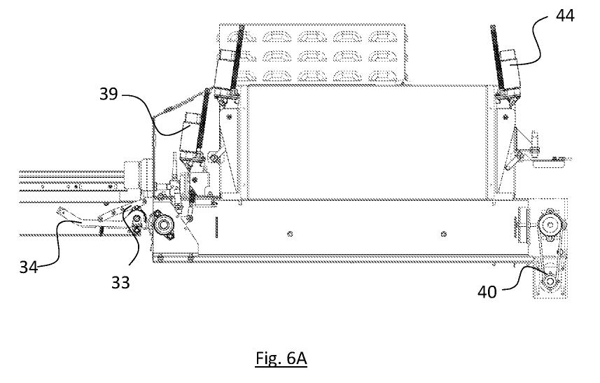

FIGS. 5A and 5B show an infeed unit of the bake-off oven system of FIG. 1A; and

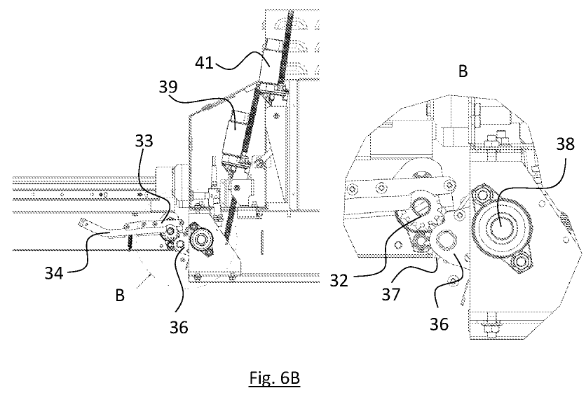

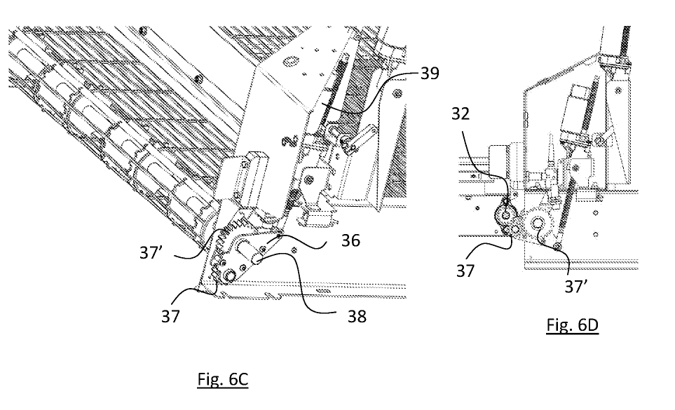

FIGS. 6A-6D show an engagement between the conveyor belts of the infeed unit and the bake-off compartment of the bake-off oven system of FIG. 1A.

FIGS. 1A-1C show an embodiment of a bake-off oven system. FIGS. 1A and 1B show here a frame 1 in which a lift system 2 is incorporated, which is shown in more detail in FIG. 2. A bake-off compartment 3 which is supported by lift system 2 is also visible.

FIG. 1B shows an infeed unit which is embodied as a trolley 4, which is shown in more detail in FIG. 5A. Frame 1 and trolley 4 are movable here on individual wheels 5, 6. Trolley 4 comprises a plurality of compartments 7. Each of the compartments 7 comprises a conveyor belt 8 which is mounted round two shafts 9 placed at a mutual distance, sec FIG. 5B. Conveyor belt 8 is manufactured here from stainless steel and comprises a perforated structure. Each of the shafts 9 comprises one or more toothed wheels 10 which engage on conveyor belt 8.

A single group of food products is held in each compartment 7. The infeed unit shown in FIG. 5A comprises nine compartments 7, whereby the bake-off oven system can prepare up to a maximum of nine different groups of food product in this arrangement.

The outfeed unit 11 shown in side view in FIG. 1C likewise comprises a plurality of compartments 12. The outfeed unit is embodied here as a housing to which frame 1 can be coupled or is coupled. Frame 1 is hereby in a determined position relative to outfeed unit 11 during use in order to achieve that lift system 2 is able to move bake-off compartment 3 to a suitable position for exporting the food products.

FIGS. 1D and 1E show respectively a front view and a rear view of outfeed unit 11. FIG. 1D shows here that compartments 12 can be provided on the front side with covers which a consumer has to operate before gaining access to the exported products.

FIG. 1F shows a detail view of a compartment 12. This comprises an obliquely placed plate 12′. Shown on the left in FIG. 1F is a compartment wherein the obliquely placed plate 12′ has been omitted. An optical sensor is hereby visible which comprises a first part 13 and second part 14. A reflector is incorporated in first part 13, while a light source with a photosensitive diode is incorporated in second part 14. If the light coming from the light source reaches the photosensitive diode via the reflector, it can be established that the degree of filling of a compartment 12 lies below a predetermined threshold.

Lift system 2 shown in FIG. 2 comprises a lift fork 16 which is coupled to a carriage 17. Lift fork 16 forms the support member which supports bake-off compartment 3. The movement of carriage 17 is guided here by a linear guide 18. Carriage 17 is further fixedly connected to a toothed belt 19 which is driven by a drive 20.

FIG. 3 shows a falling safety of lift system 2. The mechanism shown in FIG. 3 is incorporated in carriage 17 and comprises a catch 21 which is placed under spring tension by a spring 22. Catch 21 is mounted pivotally about a shaft 23 here. During normal use the catch also presses against toothed belt 19. If toothed belt 19 breaks, catch 21 will pivot and will engage in a pattern of holes 24 arranged in an upright 25 of lift system 2, whereby further falling of carriage 17 is prevented.

FIG. 4 shows a cross-section of bake-off compartment 3. This comprises a housing through which a conveyor belt 27 can move. This conveyor belt takes a perforated form and is manufactured from stainless steel.

Bake-off compartment 3 further comprises heating means 28 for heating the air in the compartment. This heated air is blown by fan 29 through holes 30 of a distributing unit. FIG. 4 shows that the heated air is supplied by the distributing unit on both the upper side and the underside of the food products to be baked off. This air is then fed back to fan 29 on the side of bake-off compartment 3 by a collecting unit formed by one or more air ducts.

FIG. 5B shows a detail view of a compartment 7 of trolley 4. This figure shows an engaging element in the form of a toothed wheel 32 which is fixedly connected to one of the two shafts 9 around which conveyor belt 8 is mounted. A protective bracket 33 is further visible which prevents products falling from trolley 4 during transport. Protective bracket 33 can co-act with a lever 34. During a rotation of lever 34 in the direction of protective bracket 33 this latter will more particularly move downward. The coupling between protective bracket 33 and lever 34 is here under spring tension by spring 35, whereby protective bracket 33 blocks the outlet of compartment 7 without an external force being exerted.

FIGS. 6A-6C show an arm 36 on which an engaging element in the form of a toothed wheel 37 is rotatably mounted. Arm 36 can rotate here relative to a shaft 38 around which the conveyor belt is mounted. Toothed wheel 37 is coupled here by means of a transmission in the form of a toothed wheel 37′ (visible in FIGS. 6C and 6D) to a shaft 38, whereby rotation of shaft 38 is transmitted to toothed wheel 37. It is noted here that toothed wheel 37′ is mounted on shaft 38 such that arm 36 can rotate about shaft 38, such that toothed wheels 37′, 37 remain in continuous mutual engagement.

Drive 39 can be controlled by the control unit to move arm 36 outward. A further drive 40 can be controlled to allow conveyor belt 27 to move.

The operation of the bake-off oven system will now be discussed with reference to FIGS. 5-6.

As starting situation it is assumed that trolley 4 is provided with three groups of food product, i.e. Kaiser rolls in the lower three compartments 7, croissants in the middle three compartments 7 and hard rolls in the upper three compartments 7. Outfeed unit 11 is configured here to receive the hard rolls in lower compartment 12, the Kaiser rolls in the compartment thereabove, and in the compartment lying above this the croissants.

At a given moment the optical sensor detects that the degree of filling of the Kaiser rolls is too low, i.e. below a predetermined threshold. This information is passed on to the control unit (not shown). This will then control lift system 2 to bring bake-off compartment 3 into an infeed position, wherein conveyor belt 27 of bake-off compartment 3 comes to lie in line with one of the lower three compartments 7 of trolley 4. It is possible here that trolley 4 is likewise provided with sensors for detecting the degree of filling of the different compartments 7. It can thus be achieved that bake-off compartment 3 only comes to lie in line with a compartment 7 which actually comprises enough products.

Once conveyor belt 27 of bake-off compartment 3 lies in line with conveyor belt 8 of trolley 4, the control unit will control drive 39 to move arm 36 outward. Due to this movement arm 36 will engage lever 34 and protective bracket 33 will move downward so that the outlet of compartment 7 is cleared. Toothed wheels 32, 37′ and 37 will also mutually engage. The control unit will then control drive 40 to move conveyor belt 27. This driving will however also result in driving of conveyor belt 8 via toothed wheels 37′, 37, 32, see FIG. 6D. As a result hereof the products from compartment 7 will be loaded into bake-off compartment 3. The control unit will also control drive 41 to open upstream flap 42 for the purpose of opening the oven part of bake-off compartment 3. Downstream flap 43 is closed here.

After a predetermined time the driving is stopped and it is assumed that all or at least enough products have been received from compartment 7. The control unit will then control drive 39 to rotate arm 36 back and the control unit will control drive 41 to close upstream flap 42. This flap is coupled to a brush 50 for keeping conveyor belt 27 clean. A similar brush can be provided at downstream flap 43.

After closing of upstream flap 42 the control unit will control bake-off compartment 3 to perform the baking process. For this purpose the control unit can provide bake-off compartment 3 with the correct parameters, such as temperature and/or time, specific to the group of food products. In another embodiment the control unit directly controls the relevant components, such as fan 29 and heat means 28. Conveyor belt 27 will move reciprocally during baking in order to prevent burns.

After the relevant baking time has elapsed, the control unit will control lift system 2 to bring bake-off compartment 3 to the relevant outfeed position, such that the outlet of bake-off compartment 3 is in a suitable position relative to upper compartment 12 of outfeed unit 11. The control unit will then control drive 44 to open downstream flap 43 and drive 40 to transport the baked-off Kaiser rolls to the lower compartment 12 of outfeed unit 11.

The above described process can be performed automatically. Personnel can be informed here as to the degree of filling of trolley 4 such that it can be replenished in time, for instance during a baking cycle. The use of the system is simplified considerably by associating compartments 7, 12 with groups of food products and the corresponding programming or actuation of bake-off compartment 3. This is because a user need only replenish trolley 4 when necessary.

It will be apparent to the skilled person that the invention is not limited to the above described embodiment but that different modifications are possible without departing from the scope of protection defined by the following claims.

1. A bake-off oven system, comprising:
an infeed unit for holding food products to be baked off;
a bake-off compartment for baking off food products to be baked off which are present in the infeed unit; and
an outfeed unit for holding the food products baked off by the bake-off compartment;
wherein the infeed unit and the outfeed unit each comprise a plurality of compartments, and the bake-off oven system further comprises a lift system for moving the bake-off compartment between the compartments of the infeed unit and the compartments of the outfeed unit.

2. The bake-off oven system as claimed in claim 1, wherein
each compartment of the outfeed unit is associated with a different outfeed position, and wherein, if the bake-off compartment is in a determined outfeed position, the bake-off compartment and the outfeed unit are configured to transport the food products baked off in the bake-off compartment to the compartment of the outfeed unit associated with the determined outfeed position; and
each compartment of the infeed unit is associated with a different infeed position, and wherein, if the bake-off compartment is in a determined infeed position, the bake-off compartment and the infeed unit are configured to transport the food products to be baked off, which are situated in the compartment of the infeed unit associated with the determined infeed position, to the bake-off compartment; and
the lift system is configured to move the bake-off compartment between the infeed positions and outfeed positions.

3. The bake-off oven system as claimed in claim 2, wherein, when the bake-off compartment is in one of the outfeed positions, the bake-off compartment is in line with the compartment of the outfeed unit associated with this outfeed position, and wherein, when the bake-off compartment is in one of the infeed positions, the bake-off compartment is in line with the compartment of the infeed unit associated with this infeed position.

4. The bake-off oven system as claimed in claim 3, wherein the lift system is configured to move the bake-off compartment between the infeed position and the outfeed position by at least one of a horizontal and a vertical displacement of the bake-off compartment.

5. The bake-off oven system as claimed in claim 1, wherein each of the compartments of the outfeed unit is provided with a respective sensor for detecting a degree of filling of the associated compartment, the bake-off oven system further comprising a control unit for controlling the lift system and the bake-off compartment based on the detected degree of filling of the compartments of the outfeed unit.

6. The bake-off oven system as claimed in claim 5, wherein each compartment of the infeed unit and each compartment of the outfeed unit is associated with one of a plurality of groups of food products to be baked off, wherein the control unit is configured to control the lift system after the control system detects that the degree of filling of a relevant compartment of the outfeed unit is less than a predetermined threshold value, such that the bake-off compartment is brought into an infeed position in order to receive from the infeed unit food products to be baked off, which belong to the group associated with this associated compartment, to control the bake-off compartment to bake off the food products to be baked off, and to control the lift system such that the bake-off compartment is brought into a position to export he food products to the associated compartment in order to increase the degree of filling.

7. The bake-off oven system as claimed in claim 1, wherein the bake-off compartment comprises a conveyor belt and a drive unit for driving the conveyor belt.

8. The bake-off oven system as claimed in claim 7, wherein the drive unit is configured to move the conveyor belt up and downward, at least during baking off of the food products.

9. The bake-off oven system as claimed in claim 7, wherein each compartment of the infeed unit comprises an individually movable conveyor belt which can be coupled to the conveyor belt of the bake-off compartment such that after coupling the drive unit of the bake-off compartment drives both the conveyor belt of the bake-off compartment and the movable conveyor belt of a compartment for the purpose of transporting food products to be baked off from the compartment to the bake-off compartment.

10. The bake-off oven system as claimed in claim 9, wherein the movable conveyor belt of the compartment of the infeed unit and the conveyor belt of the bake-off compartment are each mounted around a respective pair of shafts placed at a mutual distance, wherein at least one shaft of the pair of shafts of the infeed unit is coupled mechanically to a first engaging element and wherein at least one shaft of the pair of shafts of the bake-off compartment is coupled mechanically to a second engaging element, wherein the first and second engaging element are engageable with each other for said driving of the movable conveyor belt of the compartment of the infeed unit by the drive unit.

11. The bake-off oven system as claimed in claim 10, wherein the first and the second engaging element each comprise a toothed wheel.

12. The bake-off oven system as claimed in claim 9, wherein at least one of the infeed unit and the bake-off compartment comprises a pivotally mounted arm, which arm can pivot relative to the shaft to which an engaging element is coupled mechanically and wherein the engaging element is rotatably mounted on an end of the shaft remote from the shaft, wherein rotation of the shaft and rotation of the engaging element are coupled and wherein said at least one of the infeed unit and the bake-off compartment comprises a second drive unit for allowing the arm to pivot for bringing the engaging elements into engagement.

13. The bake-off oven system as claimed in claim 12, wherein the bake-off compartment comprises said pivotally mounted arm, and wherein the infeed unit comprises a pivotally mounted protective bracket per compartment, which bracket is configured to be pushed away by the pivotally mounted arm of the bake-off compartment during pivoting of the pivotally mounted arm for allowing the engaging elements to enter into engagement.

14. The bake-off oven system as claimed in claim 1, further comprising a frame on which the lift system with the bake-off compartment is mounted, wherein the infeed unit comprises a mobile trolley which is coupleable to the frame.

15. The bake-off oven system as claimed in claim 1, wherein the bake-off compartment comprises an upstream flap which is placed between the infeed unit and the bake-off compartment and a downstream flap which is placed between the bake-off compartment and the outfeed unit, and wherein the control unit is configured to open the upstream flap prior to receiving from the infeed unit the food products to be baked off, and to open the downstream flap after baking of these food products for the purpose of exporting these to the outfeed unit.

16. The bake-off oven system as claimed in claim 15, wherein the bake-off compartment comprises:
a housing;
a heat source for heating the air present in the bake-off compartment;
a fan for causing a flow in the heated air;
a distributing unit for distributing the heated air over the food products to be baked off; and
a collecting unit for collecting the air which has been distributed over the food products to be baked off;
wherein the distributing unit is in communication with a blowing side of the fan and wherein the collecting unit is in communication with a suction side of the fan;
wherein at least one of the collecting unit and the distributing unit comprises a perforated plate with a plurality of openings through which passes the air to be distributed and/or collected.

17. A method for baking off food products to be baked off, comprising:
providing a bake-off oven system as claimed in claim 1;
bringing the bake-off compartment into line with one of the compartments of the infeed unit;
transporting food products to be baked off from said one compartment of the infeed unit to the bake-off compartment for baking off the food products;
displacing the bake-off compartment to bring the bake-off compartment into line with one of the compartments of the outfeed unit; and
transporting said baked-off food products from the bake-off compartment to said one compartment of the outfeed unit.

18. A method for baking off food products to be baked off, comprising of:
providing an outfeed unit for holding baked-off food products;
providing an infeed unit for holding food products to be baked off, wherein the infeed unit and the outfeed unit each comprise a plurality of compartments, wherein each compartment of the infeed unit and outfeed unit is associated with a different group of food products;
detecting a degree of filling of each of the compartments of the outfeed unit;
wherein when the detected degree of filling of a relevant compartment lies below a predetermined threshold:
moving a bake-off compartment relative to the infeed unit using a lift system to reach a position suitable for receiving food products from the group associated with said relevant compartment, and receiving these food products;
baking off the received food products with the bake-off compartment;
moving the bake-off compartment relative to the outfeed unit using the lift system to reach a position suitable for exporting the baked-off food products to the relevant compartment; and
exporting the baked-off food products to the relevant compartment.
